(19) United States
(12) Patent Application Publication
(10) Pub. No.: US 2024/0331540 A1
(43) Pub. Date: Oct. 3, 2024

(54) CONTROL METHOD, INFORMATION PROCESSING APPARATUS, AND CONTROL APPARATUS

(71) Applicant: CANON KABUSHIKI KAISHA, Tokyo (JP)

(72) Inventor: TATSUHIKO SAKAI, Tokyo (JP)

(21) Appl. No.: 18/740,383

(22) Filed: Jun. 11, 2024

Related U.S. Application Data
(63) Continuation of application No. PCT/JP2022/043368, filed on Nov. 24, 2022.

(30) Foreign Application Priority Data
Dec. 22, 2021 (JP) 2021-208471

(51) Int. Cl. G08G 1/14; G06V 10/75; G06V 20/54; H04N 7/18

(52) U.S. Cl. CPC G08G 1/144; G06V 10/75; G06V 20/54; H04N 7/181; G06Q 2240/00; G06V 2201/08

(57) ABSTRACT

A control apparatus that operates as a broker in a publish-subscribe communication system accepts a subscribe request of a topic including identification information of a detection target from a user apparatus that operates as a subscriber, and after the subscribe request is accepted, transmits a publish instruction of the topic to an information processing apparatus that can operate as a publisher that publishes a message via the topic in a case where the detection target is detected and that has not started publishing processing as the publisher.

### CROSS-REFERENCE TO RELATED APPLICATIONS

This application is a Continuation of International Patent Application No. PCT/JP 2022/043368, filed Nov. 24, 2022, which claims the benefit of Japanese Patent Application No. 2021-208471, filed Dec. 22, 2021, both of which are hereby incorporated by reference herein in their entirety.

### BACKGROUND OF THE INVENTION

### Field of the Invention

The present invention relates to a control method, an information processing apparatus, and a control apparatus.

### Background Art

In the publish-subscribe method of communication, publishers publish via messages with identification information known as topics attached, and subscribers register with a broker to receive the published topics they want to receive (PTL 3). This allows the publisher and the subscriber to communicate without being aware of one another. This is advantageous in terms of system scalability and ease of implementation.

### CITATION LIST

### Patent Literature

PTL 1: Japanese Patent No. 6402077 PTL 2: Japanese Patent Laid-Open No. 2007-293563 PTL 3: Japanese Patent Laid-Open No. 2020-75717

Here, the subscriber may wish to obtain information indicating that the publisher has detected a predetermined detection target via publishing. In such a case, the subscriber for which the publisher publishes the information and the publisher for which the subscriber requests the publishing of the information cannot be known, causing the problem of information being unable to be efficiently published.

### SUMMARY OF THE INVENTION

The present invention has been made in consideration of the aforementioned problems and realizes a technique that can efficiently publish information indicating that a detection target has been detected using a communication system that performs publish-subscribe communication.

To solve the problems described above, a control apparatus that operates as a broker in a publish-subscribe communication system includes: accepting means for accepting a subscribe request of a topic including identification information of a detection target from a user apparatus that operates as a subscriber; and transmitting means for, after the subscribe request is accepted, transmitting a publish instruction of the topic to an information processing apparatus that can operate as a publisher that publishes a message via the topic in a case where the detection target is detected and that has not started publishing processing as the publisher.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a configuration diagram of a moving body management system including a communication system according to the present embodiment.

FIG. 2 is a block diagram illustrating an example configuration of a user apparatus.

FIG. 3 is a block diagram illustrating an example configuration of a control apparatus.

FIG. 4 is a block diagram illustrating an example configuration of a detection apparatus.

FIG. 5 is a flowchart illustrating an example of processing executed by the control apparatus when a registration request is received.

FIG. 6 is a flowchart illustrating an example of processing executed by an information processing apparatus when a publish instruction is received.

FIG. 7 is a diagram illustrating an example of an information table illustrating the association between topic names and vehicle identifiers.

FIG. 8 is a flowchart illustrating an example of the processing executed by the information processing apparatus when a vehicle is detected.

FIG. 9 is a flowchart illustrating an example of processing executed by the control apparatus when a registration release request is received.

FIG. 10 is a flowchart illustrating an example of processing executed by the information processing apparatus when a publishing stop instruction is received.

FIG. 11A is a sequence diagram illustrating an example of processing executed by a moving body management system.

FIG. 11B is a sequence diagram illustrating an example of processing executed by the moving body management system.

FIG. 12 is a diagram of a computer management system including a communication system according to a second embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

With a traffic system recently proposed (PTL 2), traffic information is obtained using images and sensor information obtained by a camera and sensor installed at or near a road for vehicles.

Also, in an automated valet parking system (PTL 3), a vehicle is moved and autonomously parked in an empty parking space without a driver using communication between infrastructure and the vehicle.

By introducing the traffic system described above to the automated valet parking system, the position of a vehicle in the parking area is detected by a camera and the like and the user of the vehicle is notified of the position information of the vehicle. This informs the user of the state of the vehicle during parking and the state of the vehicle at the parking position and the like.

In this case, the topic setting content needs to be shared between the publisher, a surveillance camera for example, and the subscriber, the smartphone of the owner of the vehicle for example, before communication. However, in an environment such as a parking area with an unspecified number of vehicles coming and going, it is impossible to known in advance what kind of subscriber will join the system, making it difficult to appropriately share the topic setting content in advance.

For example, conceivably, a method may be used in which content topics for transmitting all of the vehicle positions recognized by a surveillance camera are shared in advance. However in this case, the processing load on the surveillance camera side increases due to executing the processing for all of the recognized vehicles. In addition, there is the problem of poor efficiency since even vehicle position information not required on the smartphone side is transmitted and received.

In this manner, for an environment where the configuration of the subscribers changes, a method for appropriately determining the topic settings and sharing them between the publisher and the subscriber are problematically not set.

To solve such a problem, in a first embodiment described herein, a moving body management system, that is, an automated valet parking system that assists with the automated parking of vehicles is used as an example of a communication system that performs publish-subscribe communication.

In the present embodiment, the moving body management system publishes to a user apparatus operating as a subscriber information indicating that a vehicle has been detected as a moving body, that is, a detection target. The control apparatus operating as the broker assists with automated valet parking and instructs the publisher to publish information relating to the vehicle which is subscriber wishes to detect on the basis of the processing described below. Also, the surveillance cameras, examples of the information processing apparatus operating as a publisher, detect information such as the position of the vehicle and the like and publish a message via publish-subscribe communication. In this manner, the vehicle status can be easily known by the user of the vehicle receiving the published information via a user apparatus such as a smartphone.

System Configuration

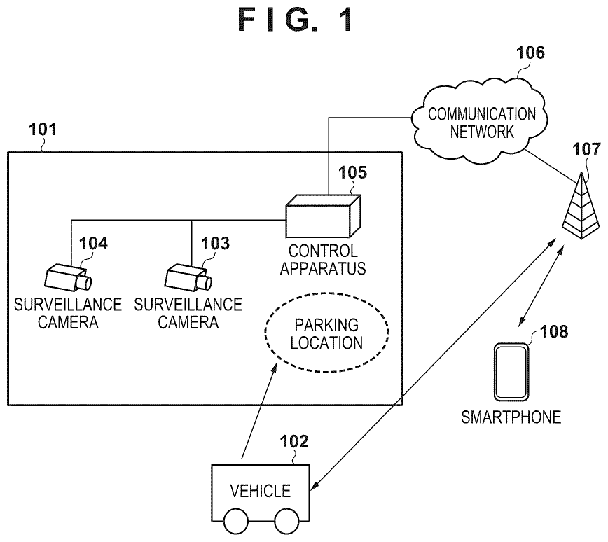

FIG. 1 is a configuration diagram illustrating a communication system according to the present embodiment. A communication system 101 that performs publish-subscribe communication is an automated valet parking system. The communication system 101 includes a control apparatus 105 that operates as a broker and surveillance cameras 103 and 104, which are information processing apparatuses that operate as publishers.

Also, in a case where a vehicle 102 capable of automated driving joins the communication system 101, the communication system 101 transmits information for assisting automated driving to the vehicle 102. Also, a smartphone 108, which is a user apparatus operating as a subscriber, owned by the user of the vehicle 102 indicates, via the communication system, the state of the vehicle 102 being automatically driven in the valet parking system 101 using the position information of the vehicle 102 or the like.

Also, the plurality of surveillance cameras 103 and 104 are installed in the parking area where the communication system 101 is used, and the control apparatus 105 comes to know the behavior of the self-driving vehicle 102 via images captured by the surveillance camera installed at each location.

In the present embodiment, the vehicle 102 self-drives to a designated parking location in the parking area via control from the control apparatus 105 of the automated valet parking system. A control message relating to automated driving transmitted from the control apparatus 105 to the vehicle 102 is sent to the vehicle 102 using wireless communication via a communication network 106 and a base station 107. For example, the control message may be a movement instruction including position information indicating a movement destination for the vehicle 102 or a steering instruction including steering information such as turn left or turn right to be performed by the vehicle 102. Also, the vehicle 102 transmits its status information and the like to the control apparatus 105 using wireless communication via the base station 107.

The surveillance cameras 103 and 104 are installed in the parking area and are apparatuses that can capture images of the traffic state in the parking area, analyze the travelling vehicles from the captured image data using image processing, and notify another device of the analysis results.

The surveillance cameras have a function of publishing information relating to the vehicle 102 via the communication network 106 and the base station 107 to the smartphone 108 of the owner of the vehicle 102 when the surveillance camera detects the vehicle 102. In other words, a surveillance camera can operation as a publisher in the communication system 101 that performs publish-subscribe communication.

This publishing function is implemented by publish-subscribe messaging via the control apparatus 105. In other words, according to the present embodiment, the surveillance cameras 103 and 104 correspond to the publisher, the control apparatus 105 corresponds to the broker, and the smartphone 108 corresponds to the subscriber, and messaging is performed using topics.

In the present embodiment, for example, after the vehicle 102 has entered the automated valet parking system 101, the owner of the vehicle 102 may operate the smartphone 108 to start use of the publishing function described above. Also, for example, when the vehicle 102 leaves the automated valet parking system 101, the owner of the vehicle 102 may operate the smartphone 108 to end use the publishing function described above. Also, in an example, on the basis of the position information obtained by the smartphone 108, when the smartphone 108 or the vehicle 102 enter within the area of a predetermined position, use of the publishing function described above may start via communication with the control apparatus 105. Alternatively, the communication system 101 may include a detection apparatus that detects that the smartphone 108 has joined the communication system 101 as a subscriber via a short-range wireless communication method such as an RFID tag. In this case, on the basis of a predetermined action being performed, such as a user putting the smartphone 108 against a detection apparatus, the smartphone 108 may start use of the publishing function described above.

Next, the configuration of the surveillance cameras 103 and 104, the control apparatus 105, and the smartphone 108 according to the present embodiment will be described. Note that the configuration described below is simply one example, and at least a part of the configuration described below may be replaced by other configurations with similar functions, may be omitted, or other configurations may be added in addition to the configurations described below. Furthermore, one block described in the description below may be one block divided into a plurality of blocks or may be a plurality of blocks merged as a single block. In a similar manner, at least one or more of the functions may be implemented by another apparatus, and one function may be implemented by a plurality of apparatuses.

Smartphone Configuration

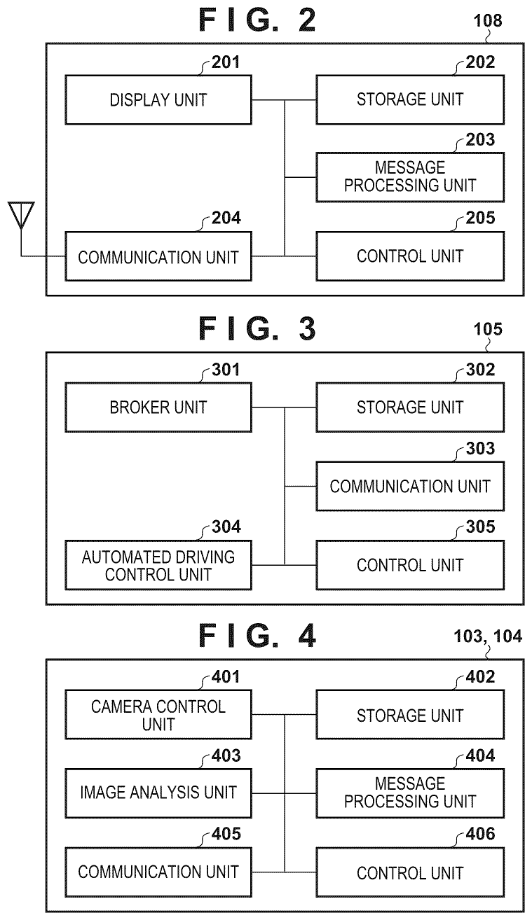

FIG. 2 is a diagram illustrating an example configuration of the smartphone 108 according to the present embodiment. The smartphone 108 includes a display unit 201, a storage unit 202, a message processing unit 203, a communication unit 204, and a control unit 205.

The display unit 201 is a display apparatus that displays information to the user. In the present embodiment, for example, notification processing is executed to display, to the user, position information of the vehicle 102 received from the surveillance cameras. The storage unit 202 is a storage apparatus that stores topics information and the like required for publish-subscribe communication. The storage unit 202 stores programs executed by the control unit 205 and various types of data such as information relating to the vehicle 102.

The message processing unit 203 is a message processing unit that implements messaging communication on the basis of publish-subscribe communication. In the present embodiment, the message processing unit 203 implements processing on the subscriber side.

The communication unit 204 is a communication unit that transmits messages generated by the message processing unit, messages generated by the control unit 205, and the like using public wireless communication via the base station 107. Also, the communication unit 204 is responsible for processing for receiving messages and the like from another apparatus via the base station 107.

The control unit 205 is a control unit that controls the functions in the smartphone and performs control.

Control Apparatus Configuration

FIG. 3 is a diagram illustrating an example configuration of the control apparatus 105 according to the present embodiment. The control apparatus 105 includes a broker unit 301, a storage unit 302, a communication unit 303, an automated driving control unit 304, and a control unit 305.

The broker unit 301 acts as an intermediary for communication between the publish apparatus and the subscribe apparatus in publish-subscribe communication via the communication unit 303.

An example of the processing executed by the broker unit 301 will be described below. When the broker unit 301 receives a subscribe registration request (subscribe request) transmitted from another apparatus, the broker unit 301 associates the apparatus with the IP address, the port number, and the like and the desired topic and stores this in the storage unit 302. Also, when a publishing request is received from another apparatus, if a subscribe registration request for the topic of the publishing request has been received, message publishing to the apparatus is performed. In other words, the broker unit 301 functions as an accepting unit that accepts subscribe request messages and a transfer unit that transfers messages from the publisher.

The communication unit 303 includes a wireless communication circuit and transmits and receives publish-subscribe messages, including receiving subscribe requests and transmitting publish requests, to be processed by the broker unit 301.

The automated driving control unit 304 transmits and receives control messages for controlling automated driving of a vehicle driving in the parking area. The control apparatus 105 controls the automated driving of the vehicle 102 on the basis of information obtained from the surveillance cameras or the vehicle and guides the vehicle 102 by instructing the vehicle 102 to the desired parking location in the parking area.

The control unit 305 controls the functions in the control apparatus 105 described above and performs control. In an example, the control unit 305 includes a processor and memory.

Surveillance Camera Configuration

FIG. 4 is a diagram illustrating an example configuration of the surveillance cameras 103 and 104 according to the present embodiment. The surveillance cameras 103 and 104 each include a camera control unit 401, a storage unit 402, an image analysis unit 403, a message processing unit 404, a communication unit 405, and a control unit 406.

The camera control unit 401 executes typical processing of a camera function including image capture and obtains image data from an image capture apparatus such as a camera. In an example, the camera control unit 401 may control the magnification by zooming in or out, and in a case where the surveillance cameras 103 and 104 each include a movable portion with a controllable imaging area, the camera control unit 401 may control the imaging area.

The storage unit 402 stores information relating to the camera function, position information of the camera apparatus, and a correspondence table of vehicle identifiers and topic names included in the publish instruction transmitted from the control apparatus 105 described below. Also, programs executed by the control unit 406 and various types of data used in the operations of the surveillance cameras 103 and 104 are stored.

The image analysis unit 403 analyzes the images obtained from the camera via the camera control unit 401. Specifically, the image analysis unit 403 has a function for detecting a vehicle driving in the parking area from a captured image and obtaining the identification information of the vehicle. In an example, the vehicle identification information is the vehicle registration number of the vehicle. Also, the vehicle identification information may be the vehicle type.

The message processing unit 404 executes messaging communication on the basis of publish-subscribe communication. The message processing unit 404 implements the processing on the publisher side and generates messages for publishing messages on the basis of the analysis result from the image analysis unit 403. The publishing processing will be described below in detail.

The communication unit 405 transmits and receives the messages generated at the message processing unit 404 and the like to/from another apparatus of the communication system 101. The control unit 406 is a control unit that controls the functions in the surveillance cameras 103 and 104 and performs control. In an example, the control unit 406 includes a processor and memory.

Example of Processing upon Receiving Registration Request

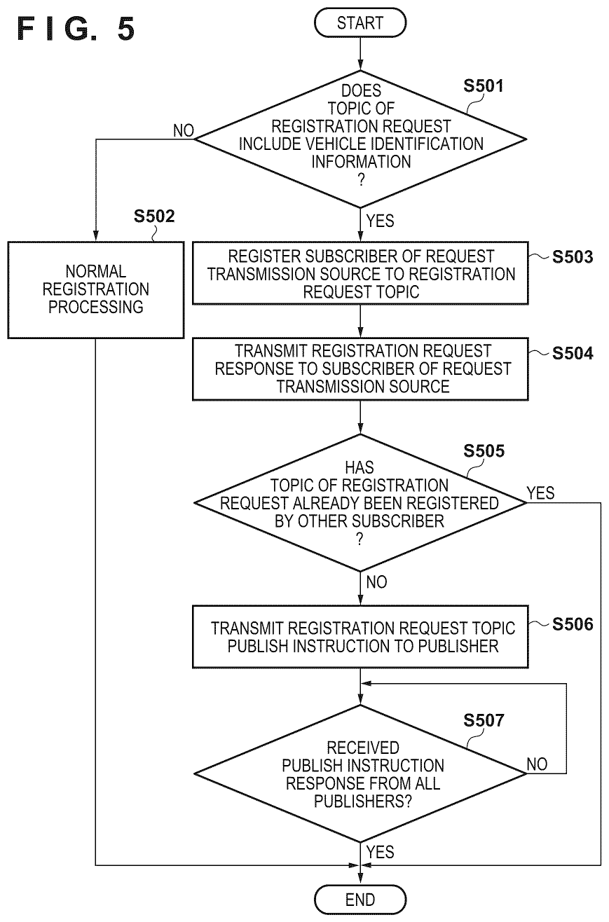

FIG. 5 is a diagram illustrating a flowchart of the processing executed by the control apparatus 105 according to the present embodiment when a registration request is received.

In the present embodiment, the processing upon receiving a registration request is started at the control unit 305 when the control apparatus 105 receives a registration request from the smartphone 108. Also, the flowchart illustrated in FIG. 5 is executed by the control unit 305 reading out and executing a computer program stored in the storage unit 302.

The registration request according to the present embodiment is transmitted for the purpose of sending a request to register a subscription to a designated topic from the subscriber (smartphone 108) to the broker (control apparatus 105). A registration release request may be transmitted using a SUBSCRIBE message of MQTT (Message Queueing Telemetry Transport) protocol, for example. Also, a registration release request may be referred to as an unsubscribe request.

First, in step S501 (hereinafter, simply referred to as S501, and this also applies to other processing steps), the control unit 305 checks whether or not the topic name included in the registration request includes the vehicle identification information. In a case where a topic starting with [Carnum/] is included in the registration request, for example, the control unit 305 may determine that the vehicle identification information is included in the contents of the topic name to be checked in S501. The smartphone 108 may transmit a registration request with [Carnum/] NEWYORK_ABC2345 designated as the topic, for example. In this case, the registration request is a request to register a subscription to a topic relating to a vehicle with the vehicle identifier [NEWYORK_ABC2345].

Note that in the present embodiment, that the topic starting with [Camnum/] includes vehicle identification information is shared in advance in the communication system 101 of the subscriber, the broker, and the publisher.

In a case where the topic does not include the vehicle identification information (No in S501), the control unit 305 determines that a normal registration request has been received and executes normal subscription registration processing (S502). In other word, when the broker receives a registration request message with a topic that does not include vehicle identification information from the publisher, the broker performs routing setting so that the message is transferred to the subscriber that is the transmission source of the registration request.

The routing setting may include registering the topic name included in the registration request and the information of the subscriber that is the transmission source of the registration request into a routing table in which the topics and the IP address of the transfer destination apparatus, port number, and the like are associated together.

In this manner, when the broker receives a message including a topic name from the publisher, the broker references the routing table, allowing it to transfer the message to the subscribed subscriber.

Note that in a case where the topic included in the registration request is a topic that is not shared in advance between the apparatuses, the broker determines that the registration request is a false registration request and does not perform the routing setting. In other words, in a case where the topic included in the registration request is not a topic registered with the publisher and does not start with [Carnum/] as described above, the broker may not perform routing setting for the registration request.

In a case where the topic includes the vehicle identification information (Yes in S501), the control unit 305 registers the subscription to the topic with the topic name included in the registration request (S503). In other words, when the broker receives a message including the topic name included in the registration request from the publisher, the broker performs routing setting so that the message is transferred to the subscriber that is the transmission source of the registration request.

The routing setting may include registering the topic included in the registration request and the IP address of the subscriber that is the transmission source of the registration request in the routing table of the storage unit 302 in which the topics and the IP addresses of the transfer destination apparatuses are associated together.

After registration, the control unit 305 transmits a registration request response to the subscriber that is the transmission source of the registration request (S504). The registration request response according to the present embodiment is transmitted as an acknowledgement of the registration request from the subscriber. The registration request response may be transmitted using a SUBACK message of MQTT protocol, for example.

Next, the control unit 305 checks whether or not the topic included in the registration request has already been registered by another subscriber (S505). In other words, the control unit 305 references the routing table described in S503 and checks whether the topic included in the registration request is associated with a subscriber other than the subscriber that is the transmission source of the registration request.

In a case where the topic is not registered with another subscriber (No in S505), the control unit 305 transmits a publish instruction to the surveillance cameras 103 and 104 instructing them to publish the topic included in the registration request (S506).

In S506, the publish instruction to be transmitted includes at least the topic of the information to be transmitted. Also, the publish instruction may be transmitted to each surveillance camera installed in the parking area from the control apparatus 105 using unicast communication or may be published to each surveillance camera via broadcast communication.

In a case where the registration request topic is registered with another subscriber (Yes in S505), the control unit 305 determines that the publish instruction of the topic has already been transmitted and ends the processing. Next, in S506, the control unit 305 waits for a publish instruction response from the publisher and ends the processing in a case where a publish instruction response is received from all of the publishers (S507).

### Example of Processing upon Receiving Publish Instruction

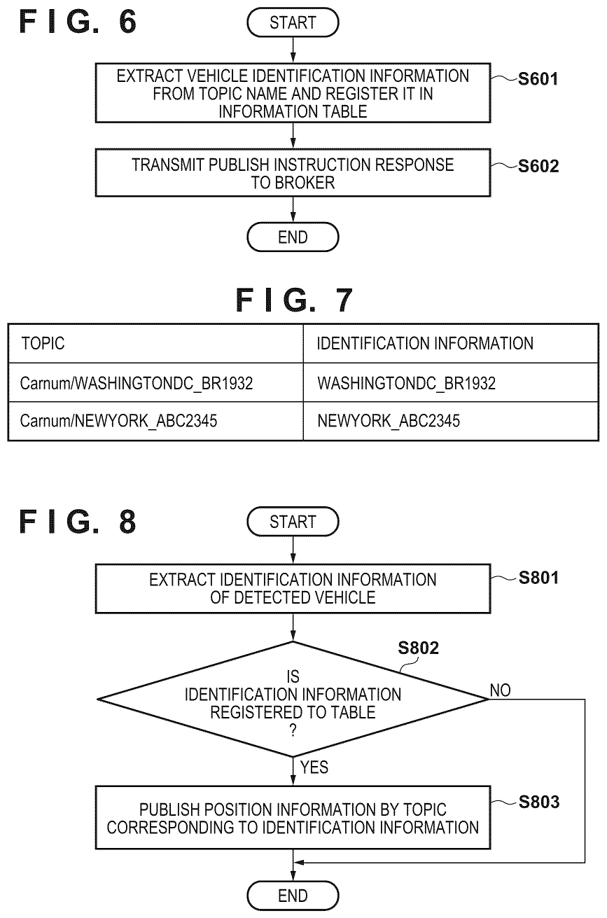

FIG. 6 is a diagram illustrating a flowchart of the processing executed by the surveillance cameras 103 and 104 according to the present embodiment when a publish instruction is received.

In the present embodiment, the processing upon receiving a publish instruction is started at the control unit 406 when the surveillance cameras 103 and 104 receive a publish instruction from the control apparatus 105. Also, the flowchart illustrated in FIG. 6 is executed by the control unit 406 reading out and executing a computer program stored in the storage unit 402.

After processing starts, the control unit 406 extracts the identification information of the vehicle from the topic included in the publish instruction and associates together the topic and the vehicle identification information and registers them in an information table stored in the storage unit 402 (S601).

An example of the information table in which the vehicle identification information and the topics are associated together is illustrated in FIG. 7. In the publishing processing described below, the surveillance cameras 103 and 104 publishes via the topic corresponding to the detected vehicle by referencing the information table. After registration, the control unit 406 transmits a response to the publish instruction to the control apparatus 105 (S602).

The response to be transmitted in S602 may be transmitted when the registration processing in S601 has been completed as normal. Alternatively, the response may be transmitted including the processing result.

Processing upon Vehicle Detection

FIG. 8 is a diagram illustrating a flowchart of the processing executed by the surveillance cameras 103 and 104 according to the present embodiment when a vehicle is detected.

In the present embodiment, the processing upon vehicle detection is started at the control unit 406 when the surveillance cameras 103 and 104 detects a vehicle from the captured images. Also, the flowchart illustrated in FIG. 8 is executed by the control unit 406 reading out and executing a computer program stored in the storage unit 402.

First, the control unit 406 extracts the identification information of the detected vehicle from the captured images (S801). After extraction, the control unit 406 references the information table stored in the storage unit 402 and checks whether or not the extracted vehicle identifier is registered in the information table (S802).

In a case where it is registered in the information table (Yes in S802), the control unit 406 publishes the position information of the detected vehicle using the topic corresponding to the extracted vehicle identifier and ends the processing (S803).

Note that the vehicle position information to be published in S803 may be obtained by calculating the geographical position of the vehicle from the captured images and published. Also, the position information of the camera which detected the vehicle may be published as the vehicle position information. As the camera position information, camera position information measured in advance using GPS or the like may be stored in the storage unit 402. Alternatively, the position of vehicle may be text information on the smartphone 108 that the user can understand, such as “surveillance camera at point A on the 2nd floor of the parking area”, for example. Alternatively, in S803, image data captured by a camera may be published together with the position information.

Processing upon Receiving Registration Release Request

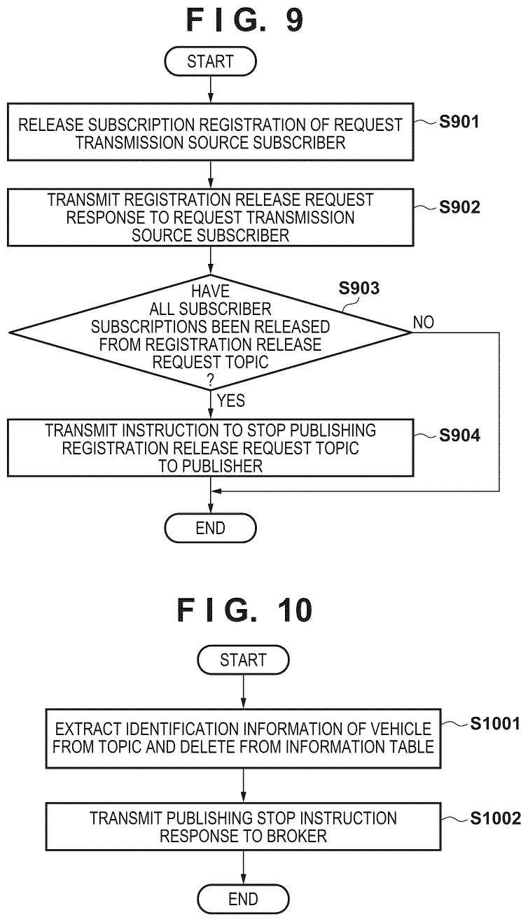

FIG. 9 is a diagram illustrating a flowchart of the processing executed by the control apparatus 105 according to the present embodiment when a registration release request is received.

In the present embodiment, the processing upon receiving a registration release request is started at the control unit 305 when the control apparatus 105 receives a registration release request from the smartphone 108. Also, the flowchart illustrated in FIG. 9 is executed by the control unit 305 reading out and executing a computer program stored in the storage unit 302.

The registration release request according to the present embodiment is transmitted for the purpose of sending a request from the subscriber to the broker to release the registration of a currently registered topic. The registration release request may be transmitted using an UNSUBSCRIBE message of MQTT protocol, for example.

The control unit 305 releases the subscription registration of the subscriber that is the transmission source of the message for the topic included in the registration release request (S901). After release, the control unit 305 transmits a registration release request response to the subscriber that is the transmission source of the registration release request (S902). The registration release request response according to the present embodiment is transmitted as an acknowledgement of the registration release request from the subscriber. The registration release request response may be transmitted using an UNSUBACK message of MQTT protocol, for example. The control unit 305 checks whether or not all of the subscriber subscription registrations have been released from the topic included in the registration release request (S903). In a case where all of the subscriber subscription registrations have been released (Yes in S903), the control unit 305 transmits a publishing stop instruction to the publisher to stop publishing of the topic included in the registration release request and ends the processing (S904).

The publishing stop instruction transmitted in S904 includes at least the topic for which publishing to be stopped. Also, the publishing stop instruction may be transmitted to each surveillance camera installed in the parking area from the control apparatus 105 using unicast communication or may be published to each surveillance camera via broadcast communication.

Example of Processing upon Receiving a Publishing Stop Instruction

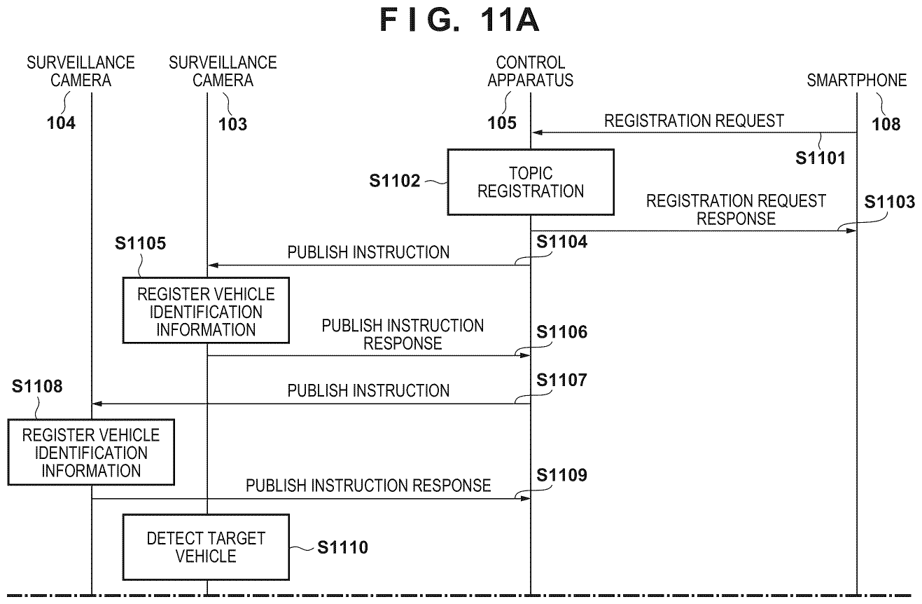

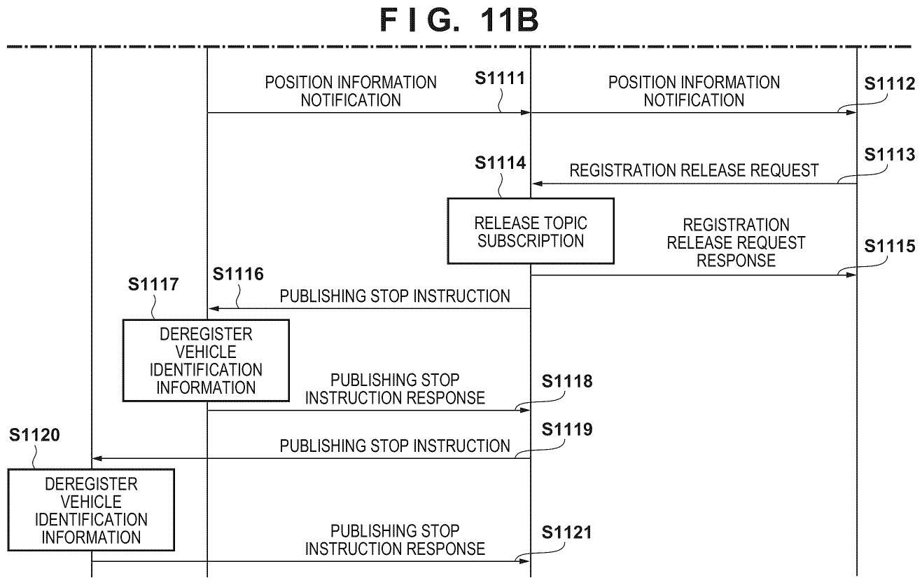

FIG. 10 is a diagram illustrating a flowchart of the processing executed by the surveillance cameras 103 and 104 according to the present embodiment when a publishing stop instruction is received. In the present embodiment, the processing upon receiving a publishing stop instruction is started at the control unit 406 when the surveillance cameras 103 and 104 receive a publishing stop instruction from the control apparatus 105. Also, the flowchart illustrated in FIG. 6 is executed by the control unit 406 reading out and executing a computer program stored in the storage unit 402.

The control unit 406 extracts the identification information of the vehicle from the topic included in the publishing stop instruction and deletes the entry corresponding to the identification information of the vehicle extracted from the information table stored in the storage unit 402 (S1001). In this manner, the publishing processing described with reference to S803 is not executed, allowing the publishing processing for the designated vehicle identifier to be stopped.

After deletion, the control unit 406 transmits a publishing stop instruction response to the broker and ends the processing (S1002). The publishing stop instruction response transmitted in S1002 may be transmitted when the deletion processing in S1001 is completed as normal. Alternatively, the response may be transmitted including the processing result.

### Example of Communication System Processing

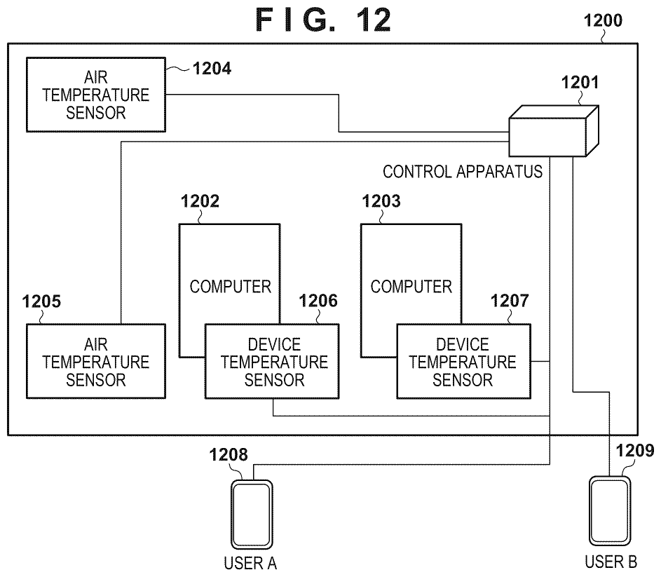

FIGS. 11A and 11B illustrate a sequence of the processing operations according to the present embodiment.

The smartphone 108 transmits a registration request for a topic in which to publish the information of the vehicle 102 to the control apparatus 105 (S1101).

In S1101, for example, in a case where the vehicle identification information of the vehicle 102 is [NEWYORK_ABC2345], a registration request designating [Camnum/NEWYORK_ABC2345] as the topic is transmitted.

When the control apparatus 105 receives the registration request, the control apparatus 105 executes the processing upon receiving a registration request illustrated in FIG. 5 and registers the smartphone 108 with the topic included in the registration request (S1102 and S503).

After registration with the topic, the control apparatus 105 transmits a registration request response to the smartphone 108 (S1103 and S504).

The control apparatus 105 checks whether the topic included in the registration request is not already registered by another subscriber (No in S505) and transmits a publish instruction to the surveillance cameras 103 and 104 (S1104, S1107, and S506). When the surveillance cameras 103 and 104 receive the publish instruction of S1104 and S1107, the surveillance cameras 103 and 104 execute the processing upon receiving a publish instruction illustrated in FIG. 6, associates together the topic name and the vehicle identification information in the information table stored in the storage unit 402, and registers them (S1105, S1108, S601).

After vehicle identification information registration, the surveillance cameras 103 and 104 transmits a response to the publish instruction to the control apparatus 105 (S1106, S1109, S602).

After the response is transmitted, the surveillance cameras 103 and 104 performs detection of the target vehicle from the captured images. When the vehicle is detected from the captured images, the processing upon vehicle detection illustrated in FIG. 8 is executed (S1110).

The surveillance cameras 103 and 104 extract the vehicle identifier of the vehicle detected from the captured images (S802) and publishes the vehicle position information if the information matches the information registered in the information table (S1111, S803).

The control apparatus 105 transfers the published information to the smartphone 108 (S1112). In this manner, the user of the smartphone 108 can confirm the position information of the vehicle 102.

In a case where the user wishes to leave the parking area with their vehicle 102 or the like, the smartphone 108 of the user transmits a registration release request for the topic publishing the information of the vehicle 102 to the control apparatus 105 (S1113). When the control apparatus 105 receives the registration release request, the control apparatus 105 executes the processing upon receiving a registration release request illustrated in FIG. 9 and releases the subscription registration of the smartphone 108 corresponding to the topic included in the registration request (S1114 and S901). After release, the control apparatus 105 transmits a registration release request response to the smartphone 108 (S1115 and S902).

The control apparatus 105 checks that all of the subscriber registrations have been released (Yes in S903) and transmits a publishing stop instruction of the topic to the surveillance cameras 103 and 104 (S1116, S1119, and S904). When the surveillance cameras 103 and 104 receives the publishing stop instruction, the surveillance cameras 103 and 104 executes the processing upon receiving a publishing stop instruction illustrated in FIG. 10 and deletes the entry corresponding to the vehicle identifier extracted from the publishing stop instruction from the information table (S1117, S1120, and S1001). After deletion, the surveillance cameras 103 and 104 transmit a publishing stop instruction response to the broker (S1118, S1121, and S1002).

As described above, the publisher and the subscriber can exchange a message for dynamically sharing the content of a topic via a broker. In this manner, using publish-subscribe communication, only the vehicle position information needed by the user of a smartphone can be published to the smartphone from surveillance cameras.

### Second Embodiment

In the communication system of the automated valet parking system according to the first embodiment described above, position information relating to a vehicle is published via publish-subscribe communication.

In the processing according to the second embodiment described herein, using a management system for an information processing apparatus in a data center as an example, a notification is sent via publish-subscribe communication when a detection target is detected. Note that configurations, functions, and processing that are similar to that of the first embodiment are given the same reference sign and description thereof will be omitted.

In a management system 1200 in a data center, management of computers 1202 and 1203 in operation is performed via sensor nodes with a communication function. In FIG. 12, the sensor nodes correspond to temperature sensors 1204 and 1205 and device temperature sensors 1206 and 1207 (hereinafter, these may be referenced as sensor nodes 1204 to 1207 without distinction). The air temperature sensors 1204 and 1205 are sensors that detect the air temperature of the data center, and the device temperature sensors 1206 and 1207 are sensors that detect the internal temperature of a device such as the storage apparatus, the processor, and the like of the computers 1202 and 1203. In the present embodiment, the sensor nodes 1204 to 1207 operate as publishers in the publish-subscribe communication. Also, smartphones 1208 and 1209 of users A and B operate as subscribers in the publish-subscribe communication. Also, a control apparatus 1201 operates as a broker in the publish-subscribe communication.

In this example, user A and user B have different management goals. User A has the goal of detecting that the air temperature inside the data center is equal to or greater than a predetermined temperature and is a user in charge of managing the air conditioning, for example. User B has the goal of detecting that the temperature of the computers 1202 and 1203 is equal to or greater than a predetermined temperature and is a user in charge of managing apparatus maintenance, for example.

In this case, users A and B have different detection targets. In the present embodiment, in a case where the room temperature is greater than 20 degrees, user A requests for publishing of that position information, and in a case where the device temperature is greater than 80 degrees, user B requests for publishing of that apparatus information. In this case, the smartphone 1208 may transmit a registration request including [airtemp/more20] as the topic to the control apparatus 1201. Note that this topic is a combination of [airtemp] indicating that the detection target relates to the room temperature and [more20] indicating the condition of being equal to or greater than 20 degrees. Also, the smartphone 1209 may transmit a registration request including [devtemp/more80] as the topic to the control apparatus 1201. Note that this topic is a combination of [devtemp] indicating that the detection target relates to the device temperature and [more80] indicating the condition of being equal to or greater than 80 degrees.

In a case where the control apparatus 1201 accepts a registration request and the topic is [airtemp], the control apparatus 1201 transmits a publish instruction to the air temperature sensors 1204 and 1205. In a case where the request includes [devtemp] as the topic, a publish instruction is transmitted to the device temperature sensors 1206 and 1207. In other words, the control apparatus 1201 may select the information processing apparatus that can operate as the publisher to transmit the publish instruction according to the topic of the received registration request. This can suppress an increase in the detection targets that the information processing apparatus in the communication system has to detect.

Also, the detection target in the first embodiment corresponds to detecting a vehicle, but the detection target may be an event such as the air temperature or device temperature being equal to or greater than a predetermined value or the like.

Also, in the first embodiment, the information processing apparatus that detects the detection target is a surveillance camera and the detection target is detected on the basis of captured image data. However, the detection target may be detected using another detection apparatus such as a sensor or the like.

The present invention can provide a technique that can efficiently publish information indicating that a detection target has been detected using a communication system that performs publish-subscribe communication.

### Other Embodiments

The present invention is not limited to the embodiments described above. Various modifications are possible, and various embodiments are applicable without departing from the scope of the present invention. For example, by designating the topic name including information identifying a person as the identification information from the subscriber, information relating to that person may be published from the publisher.

In the first embodiment described above, the surveillance cameras 103 and 104 specify the identification information of the vehicle 102 on the basis of image recognition. In another example, the data used in image recognition may be received from the smartphone 108 via the control apparatus 105. In this case, by comparing the image received from the smartphone 108 and the image data obtained by the surveillance cameras 103 and 104 in terms of similarity or the like, the identification information of the vehicle can be specified.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A control method of a control apparatus that operates as a broker in a publish-subscribe communication system, comprising:
accepting a subscribe request of a topic including identification information of a detection target from a user apparatus that operates as a subscriber; and
after the subscribe request is accepted, transmitting a publish instruction of the topic to an information processing apparatus that can operate as a publisher that publishes a message via the topic in a case where the detection target is detected and that has not started publishing processing as the publisher.

2. The control method according to claim 1, further comprising:
receiving the message of the topic from the information processing apparatus; and
transferring the received message to the user apparatus.

3. The control method according to claim 1, further comprising:
in a case where the subscribe request is accepted, registering the topic included in the subscribe request as a topic to publish.

4. The control method according to claim 3, further comprising:
in a case where a registration release request of the topic is accepted from the user apparatus, deregistering the topic included in the subscribe request from the topic to publish.

5. The control method according to claim 1, further comprising:
accepting an unsubscribe request of the topic from the user apparatus; and
transmitting an instruction to stop publishing a message via the topic to the information processing apparatus.

6. The control method according to claim 1, wherein
the detection target is a moving body.

7. The control method according to claim 6, wherein
the moving body is a vehicle, and
the identification information corresponds to a vehicle registration number of the vehicle.

8. The control method according to claim 6, wherein
the message includes at least one of position information of the information processing apparatus, identification information of the information processing apparatus, and position information of the moving body.

9. The control method according to claim 6, wherein
the information processing apparatus includes a camera that obtains captured image data of the moving body detected, and
the message includes the captured image data of the moving body.

10. The control method according to claim 9, further comprising:
obtaining image data of the moving body from the user apparatus, wherein
transmitting the image data to the information processing apparatus, wherein
the information processing apparatus detects the moving body on a basis of the image data.

11. The control method according to claim 6, wherein
the communication system is an automated valet parking system, and further comprising:
transmitting information designating a movement destination of the moving body to the moving body.

12. An information processing apparatus including hardware that can operate as a publisher in a publish-subscribe communication system and can obtain information for detecting a detection target from outside, comprising:
at least one memory and at least one processor which function as:
detecting unit configured to detect a detection target using the hardware; and
publishing unit configured to publish a message via a topic corresponding to the detection target in a case where a publish instruction of a message is received from a control apparatus operating as a broker via the topic including identification information corresponding to the detection target and the detection target is detected by the detecting unit.

13. The information processing apparatus according to claim 12, wherein
the publishing unit further receives an instruction to stop publishing the topic from the control apparatus, and
publishing of a message via the topic is stopped according to the received publishing stop instruction.

14. The information processing apparatus according to claim 12, wherein
the detection target is a moving body,
the hardware is a camera, and
the detecting unit obtains captured image data of the moving body using the camera and detects the moving body on a basis of the captured image data obtained.

15. The information processing apparatus according to claim 14, wherein
the publishing unit publishes the message including at least a portion of the captured image data obtained.

16. The information processing apparatus according to claim 14, wherein
the moving body is a vehicle,
the identification information includes a vehicle registration number of the vehicle, and
the detecting unit identifies the vehicle registration number of the vehicle via image processing.

17. The information processing apparatus according to claim 14, wherein
the detecting unit obtains image data of the moving body from the control apparatus and detects the moving body on a basis of a comparison of the captured image data and the image data.

18. The information processing apparatus according to claim 14, wherein
the communication system is an automated valet parking system, and
the information processing apparatus is a plurality of information processing apparatuses provided in a parking area.

19. A control apparatus that operates as a broker in a publish-subscribe communication system, comprising:
at least one memory and at least one processor which function as:
accepting unit configured to accept a subscribe request of a topic including identification information corresponding to a detection target from a user apparatus that operates as a subscriber: and
transmitting unit configured to. after the subscribe request is accepted. transmitting a publish instruction of the topic to an information processing apparatus that can operate as a publisher that publishes a message via the topic in a case where the detection target is detected and that has not started publishing processing as the publisher.
